(19) United States
(12) Patent Application Publication
(10) Pub. No.: US 2008/0273000 A1
(43) Pub. Date: Nov. 6, 2008

(54) METHOD OF PREVENTING FLICKER, CIRCUIT FOR PERFORMING THE METHOD, AND DISPLAY APPARATUS HAVING THE CIRCUIT

(75) Inventors: Jong-Woung PARK, Seongnam-si (KR); Kee-Han UH, Yongin-Si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/111,673

(22) Filed: Apr. 29, 2008

(30) Foreign Application Priority Data
May 2, 2007 (KR) 10-2007-0042566

(51) Int. Cl. G09G 3/36

(52) U.S. Cl. 345/89

(57) ABSTRACT

A method for preventing flicker in a display apparatus, a circuit for performing the method and a display apparatus which includes the circuit. The method includes displaying an inspection image on a plurality of sensing pixels formed in a display panel of the display apparatus, sensing an amount of light of the inspection image and outputting sensing signals corresponding to the amount of light of the inspection image, adding the sensing signals by every frame, detecting a maximum value and a minimum value of sum values of the sensing signals, producing a flicker index using the maximum value and the minimum value detected, comparing the flicker index with a predetermined threshold value such that a present common voltage applied to the display panel is maintained when the flicker index is smaller than the threshold value. Therefore, the display quality of the display apparatus may be improved.

This application claims priority to Korean Patent Application No. 2007-42566, filed on May 2, 2007, and all the benefits accruing therefrom under 35 U.S.C. §119, the contents of which in its entirety are herein incorporated by reference.

### BACKGROUND OF THE INVENTION

1. Field of the Invention

The present invention relates to a method of preventing flicker, a circuit for performing the method and a display apparatus having the circuit. More particularly, the present invention relates to a method of preventing flicker, which is capable of improving display quality of a display apparatus, a circuit for performing the method, and a display apparatus having the circuit.

2. Description of the Related Art

When a liquid crystal display (“LCD”) apparatus is driven, a flicker index may be tuned. A flicker is a light fluctuation phenomenon which is observed by a viewer and is induced by a periodic change in the intensity of light passing through a display panel of an LCD.

The flicker index is one of the specifications of a product, and is determined according to the requirements of a product user. A conventional method of preventing flicker includes using a device that measures the luminance of light, such as a luminance meter.

Flicker indexes respectively corresponding to common voltages of an LCD panel are measured through a luminance meter when the LCD panel displays an image for inspecting the flicker. An optimum flicker index of the measured flicker indexes is selected so that a common voltage corresponding to the optimum flicker index is determined. The determined common voltage is uniformly applied to products of the same model so that the flicker is prevented.

However, since the products of the same model employ panels manufactured through different processes from each other and driving circuits having different components from each other, the above-mentioned conventional method of preventing flicker may not be sufficient for preventing the flicker. In addition, since the flicker in a display apparatus may change according to temperature, the above-mentioned conventional method of preventing flicker may not be sufficient for preventing flicker.

### BRIEF SUMMARY OF THE INVENTION

The present invention has been made in an effort to solve the above-stated problems and aspects of the present invention provide a method of preventing flicker suitable to various types of flicker caused by differences in display panels or process environment.

Another aspect of the present invention provides a circuit for preventing flicker, used for performing the method of preventing flicker.

Another aspect of the present invention provides a display apparatus having the circuit for preventing flicker.

In an exemplary embodiment, the present invention provides a method of preventing flicker in a display panel of a display apparatus, the method includes displaying an inspection image on a plurality of sensing pixels formed in the display panel, sensing an amount of light of the inspection image and outputting sensing signals corresponding to the amount of light of the inspection image, adding the sensing signals by every frame, detecting a maximum value and a minimum value of sum values of the sensing signals, producing a flicker index using the maximum value and the minimum value, and comparing the flicker index with a predetermined threshold value such that a present common voltage applied to the display panel is maintained when the flicker index is smaller than the threshold value.

According to another exemplary embodiment, a circuit for preventing flicker of display panel of a display apparatus includes a sensing signal processing part which reads out sensing signals from the display panel which displays an inspection image and includes a sensor part which senses an amount of light of the inspection image and outputs sensing signals corresponding to the amount of light of the inspection image, a summing part which adds the sensing signals by every frame, a maximum/minimum detecting part which detects a maximum value and a minimum value of sum values of the sensing signals corresponding to the frames, a flicker producing part which produces a flicker index using the maximum value and the minimum value, and a determining part which maintains a common voltage of the display panel when the flicker index is smaller than a predetermined threshold value. In another exemplary embodiment, the present invention provides a display apparatus which includes a display panel which displays an inspection image and includes a sensor part which senses an amount of light of the inspection image and outputs sensing signals corresponding to the amount of light of the inspection image and a driving device which produces a flicker index based on the sensing signals and determines a common voltage of the display panel by using the flicker index.

According to the method of preventing flicker of a display panel of a display apparatus, the circuit for preventing flicker and the display apparatus having the circuit for preventing flicker, various types of flicker caused by differences in the processes or the components of a driving circuit are suitably prevented since the driving circuit prevents flicker on a display panel. Therefore, the reliability of preventing the flicker and image quality may be improved.

### BRIEF DESCRIPTION OF THE DRAWINGS

The above and other aspects, features, and advantages of the present invention will become more apparent from the following detailed description taken in conjunction with the accompanying drawings, in which:

FIG. 1 is a plan view illustrating an exemplary embodiment of a display apparatus according to the present invention;

FIG. 2 is a circuit diagram illustrating an exemplary embodiment of the sensor part shown in FIG. 1, according to the present invention;

FIG. 3 is a cross-sectional view illustrating an exemplary embodiment of the sensor part of the display apparatus shown in FIG. 1, according to the present invention;

FIG. 4 is a block diagram illustrating an exemplary embodiment of the driving circuit shown in FIG. 1, according to the present invention;

FIG. 5 is a timing diagram illustrating an exemplary embodiment of signals applied to a display panel during a frame when a preventing flicker mode is employed, according to the present invention;

FIG. 6 is an exemplary embodiment of an image displayed on the display panel when the preventing flicker mode is employed, according to the present invention;

FIG. 7 is a block diagram illustrating an exemplary embodiment of the preventing flicker circuit shown in FIG. 4, according to the present invention; and

FIGS. 8A and 8B are a flow chart illustrating another exemplary embodiment of a method for preventing flicker according to the present invention.

### DETAILED DESCRIPTION OF THE INVENTION

The present invention will now be described more fully hereinafter with reference to the accompanying drawings, in which embodiments of the invention are shown. This invention may, however, be embodied in many different forms and should not be construed as limited to the embodiments set forth herein. Rather these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

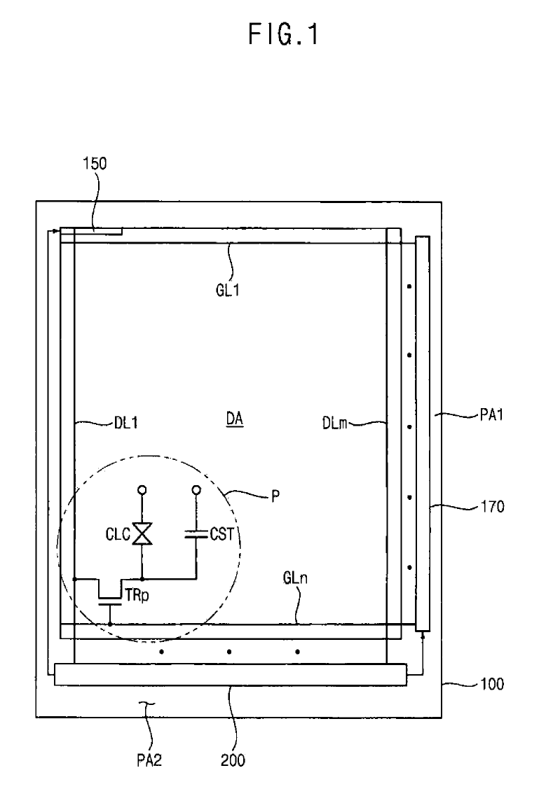

FIG. 1 is a plan view illustrating an exemplary embodiment of a display apparatus according to the present invention.

Referring to FIG. 1, a display apparatus includes a display panel 100 and a driving circuit 200 driving the display panel 100.

According to an exemplary embodiment, the display panel 100 includes a display area DA, a first peripheral area PA1 and a second peripheral area PA2. The first and second peripheral areas PA1 and PA2 surround the display area DA.

A plurality of m source lines DL1, . . . , DLm, a plurality of n gate lines GL1, . . . , GLn, (m×n) pixels P and a sensor part 150 are formed in the display area DAT wherein m and n are natural numbers. According to an exemplary embodiment, The sensor part 150 may be adjacent to the first gate line GL1 or the n-th gate line GLn.

According to an exemplary embodiment, each pixel P includes a pixel switching element TRp, a liquid crystal capacitor CLC and a storage capacitor CST. The pixel switching element TRp is electrically connected to a gate line GL1 and a source line DL1. The liquid crystal capacitor CLC and the storage capacitor CST are electrically connected to the pixel switching element TRp.

The sensor part 150 includes a plurality of sensing pixels. The sensor part 150 senses the amount of light of a displayed image for inspecting the flicker to output a sensing signal.

In an exemplary embodiment, a gate driving circuit 170 is formed in the first peripheral area PA1. The gate driving circuit 170 applies gate signals to the gate lines GL1, . . . , GLn. According to another exemplary embodiment, the gate driving circuit 170 may include a shift register integrated on the display panel 100.

The driving circuit 200 is formed in the second peripheral area PA2. According to an exemplary embodiment, the driving circuit 200 may be integrated or mounted on the second peripheral area PA2 in a form of a chip. An end portion of a flexible printed circuit board (“FPCB”) electrically connected to the driving circuit 200 may be mounted in the second peripheral area PA2.

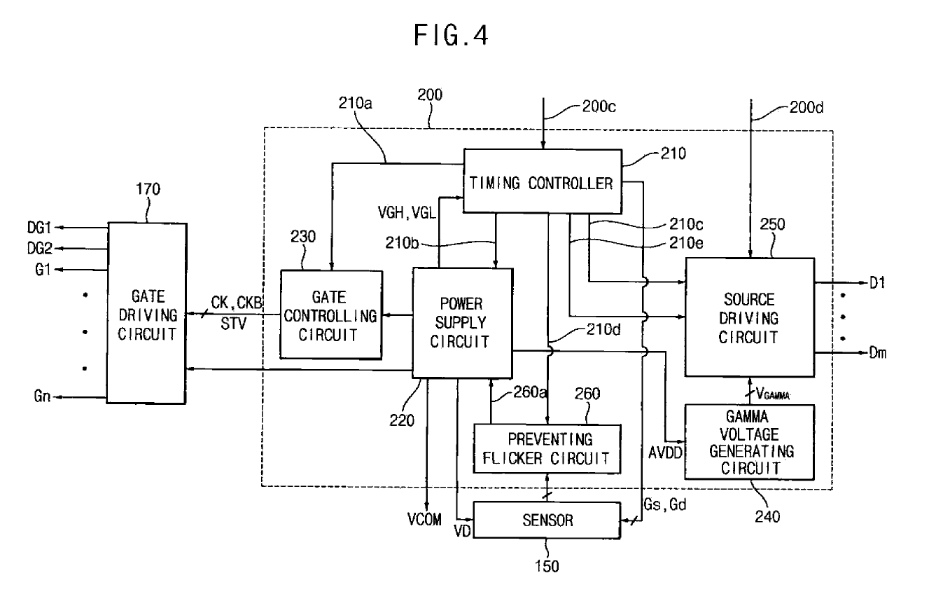

The driving circuit 200 drives the display panel 100 such that the display panel 100 displays an image. The driving circuit 200 employs a preventing flicker mode. In the preventing flicker mode, the driving circuit 200 controls a common voltage VCOM (shown in FIG. 4) to correspond to a flicker index which is smaller than or equal to a predetermined threshold value. The common voltage VCOM represents a voltage applied to a common electrode of the liquid crystal capacitor CLC of the display panel 100. Operations of the preventing flicker mode are started when the display apparatus is driven and when the display apparatus is changed from a standby mode to an operational mode.

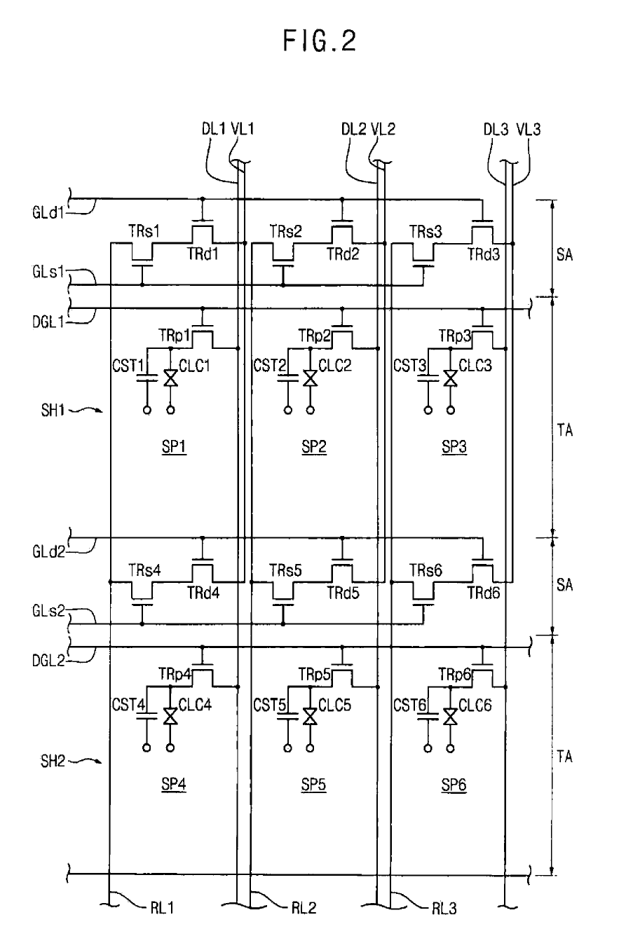

FIG. 2 is a circuit diagram illustrating an exemplary embodiment of the sensor part shown in FIG. 1, according to the present invention.

Referring to FIGS. 1 and 2, the sensor part 150 includes a plurality of sensing pixels SP1, SP2, SP3, SP4, SP5, and SP6. According to an exemplary embodiment, the sensor part 150 includes a first sensing row SH1 having a first sensing pixel SP1, a second sensing pixel SP2 and a third sensing pixel SP3 arranged therein and a second sensing row SH2 having a fourth sensing pixel SP4, a fifth sensing pixel SP5 and a sixth sensing pixel SP6 arranged therein.

The first sensing pixel SP1 of the first sensing row SH1 includes a first pixel switching element TRp1, a first liquid crystal capacitor CLC1, a first storage capacitor CST1, a first selection switching element TRs1, and a first sensing switching element TRd1. The first sensing pixel SP1 also includes a transmissive area TA and a sensing area SA. According to an exemplary embodiment, the first pixel switching element TRp1, the first liquid crystal capacitor CLC1 and the first storage capacitor CST1 are formed in the transmissive area TA and the first sensing switching element TRd1 and the first selection switching element TRs1 are formed in the sensing area SA.

The first liquid crystal capacitor CLC1 includes a pixel electrode, a common electrode and a liquid crystal layer. According to an exemplary embodiment, the pixel electrode may be formed on a portion of an array substrate corresponding to the transmissive area TA, the common electrode may be formed on a portion of a color filter substrate corresponding to the transmissive area TA, and the liquid crystal layer may be interposed between the array substrate and the color filter substrate. The pixel electrode is not formed on a portion of the array substrate corresponding to the sensing area SA having the first selection switching element TRs1 formed therein. According to an exemplary embodiment, when the pixel electrode is not formed in the sensing area SA, the liquid crystal in the sensing area SA is in normal state, in which the arrangement of liquid crystal molecules is not changed, so that light passing through the transmissive area TA and reflected by a reflective member may arrive at the first sensing transistor TRd1 without any change in light intensity.

According to an exemplary embodiment, the first pixel switching element TRp1 is electrically connected to a first dummy gate line DGL1 and the first source line DL1. The first liquid crystal capacitor CLC1 and the first storage capacitor CST1 are electrically connected to the first pixel switching element TRp1.

The first selection switching element TRs1 is electrically connected to a first sensing gate line GLs1 and a first readout line RL1.

The first sensing switching element TRd1 is electrically connected to a first driving gate line GLd1 and a first voltage line VL1. The first sensing switching element TRd1 is electrically connected to the first selection switching element TRs1.

The second and third sensing pixels SP2 and SP3 of the first sensing row SH1 may have substantially the same structure as the first sensing pixel SP1. Thus, further explanation of the second and third sensing pixels SP2 and SP3 will be omitted.

The fourth sensing pixel SP4 of the second sensing row SH2 includes a fourth pixel switching element TRp4, a fourth liquid crystal capacitor CLC4, a fourth storage capacitor CST4, a fourth selection switching element TRs4, and a fourth sensing switching element TRd4. The fourth sensing pixel SP4 includes the transmissive area TA and the sensing area SA. According to an exemplary embodiment, the fourth pixel switching element TRp4, the fourth liquid crystal capacitor CLC4 and the fourth storage capacitor CST4 are formed in the transmissive area TA and the fourth selection switching element TRs4 and the fourth sensing switching element TRd4 are formed in the sensing area SA.

The fourth liquid crystal capacitor CLC4 includes a pixel electrode, a common electrode and a liquid crystal layer. According to an exemplary embodiment, the pixel electrode may be formed on a portion of the array substrate corresponding to the transmissive area TA, the common electrode may be formed on a portion of the color filter substrate corresponding to the transmissive area TA, and the liquid crystal layer may be interposed between the array substrate and the color filter substrate. The pixel electrode is not formed on a portion of the array substrate corresponding to the sensing area SA having the fourth selection switching element TRs4 formed therein.

The fourth pixel switching element TRp4 is electrically connected to a second dummy gate line DGL2 and the first source line DL1. The fourth liquid crystal capacitor CLC4 and the fourth storage capacitor CST4 are electrically connected to the fourth pixel switching element TRp4.

The fourth selection switching element TRs4 is electrically connected to a second sensing gate line GLs2 and a second readout line RL2.

The fourth sensing switching element TRd4 is electrically connected to a second driving gate line GLd2 and a second voltage line VL2. The fourth sensing switching element TRd4 is electrically connected to the fourth selection switching element TRs4.

The fifth and sixth sensing pixels SP5 and SP6 may have substantially the same structure as the fourth sensing pixel SP4. Thus, further explanation concerning the fifth and sixth sensing pixels SP5 and SP6 will be omitted.

Hereinafter, the operation of the first sensing row of the sensor part 150 will be explained.

When a first dummy gate signal DG1 is applied to the first dummy gate line DGL1 and a inspection data for inspecting the flicker is applied to the first, second and third source lines DL1, DL2 and DL3, the first, second and third pixel switching elements TRp1, TRp2 and TRp3 are turned on so that the first, second and third sensing pixels SP1, SP2 and SP3 display an image for inspecting the flicker.

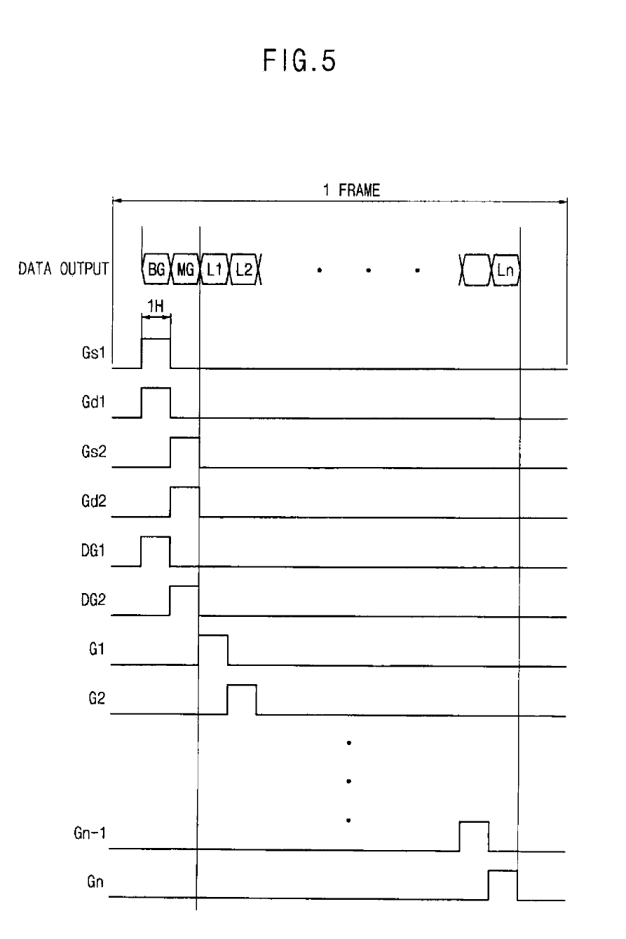

When a first driving gate signal Gd1 (shown in FIG. 5) is applied to the first driving gate line GLd1 and a sensing driving voltage VD is applied to the voltage lines VL1, VL2, and VL3, the first, second and third sensing switching elements TRd1, TRd2 and TRd3 are turned on such that a bias voltage is applied to the first, second and third selection switching elements TRs1, TRs2 and TRs3.

When a first sensing gate signal Gs1 is applied to the first sensing gate line GLs1, the first, second and third selection switching elements TRs1, TRs2 and TRs3 are turned on to sense the brightness of an image for inspecting the flicker and output signals corresponding to the brightness of the image for inspecting the flicker to the driving circuit 200 through the first, second and third readout lines RL1, RL2 and RL3.

In the second sensing row SH2, the fourth, fifth and sixth selection switching elements TRs4, TRs5 and TRs6 sense the brightness of the image for inspecting the flicker to output signals corresponding to the brightness of the image for inspecting the flicker to the driving circuit 200 through the first, second and third readout lines RL1, RL2 and RL3.

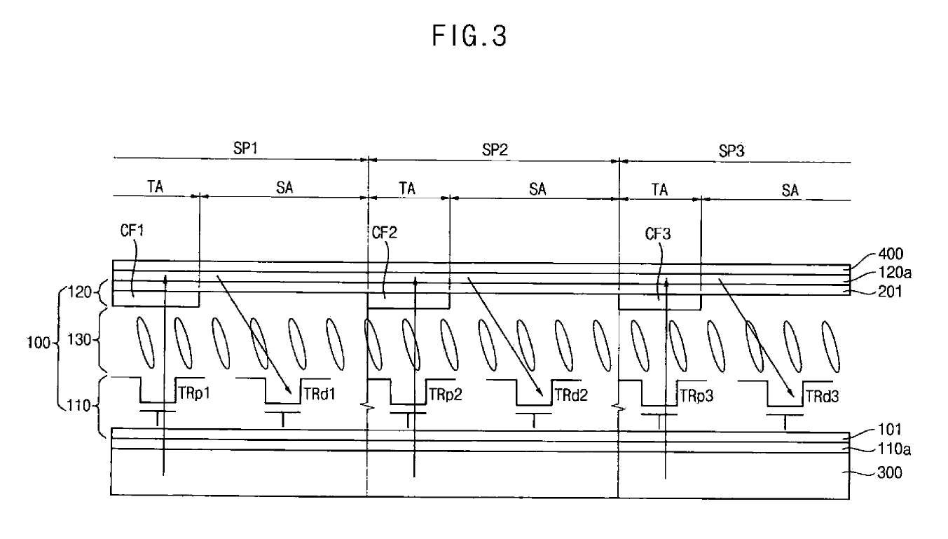

FIG. 3 is a cross-sectional view illustrating an exemplary embodiment of the sensor part of the display apparatus shown in FIG. 1, according to the present invention.

Referring to FIGS. 2 and 3, a display apparatus includes a display panel 100, a first polarizer 110a, a second polarizer 120a, a light source 300, and a reflector 400.

According to an exemplary embodiment, the display panel 100 includes an array substrate 110, a color filter substrate 120 and a liquid crystal layer 130. The array substrate 110 includes a first base substrate 101. According to an exemplary embodiment, the sensor part 150 is formed on a first surface of the first base substrate 101. The sensor part 150 includes a first pixel switching element TRp1, a first selection switching element TRs1, a second pixel switching element TRp2, a second selection switching element TRs2, a third pixel switching element TRp3, and a third selection switching element TRs3.

The color filter substrate 120 includes a second base substrate 201. A first color filter CF1, a second color filter CF2 and a third color filter CF3 are formed on a first surface of the second base substrate 201.

Each of the first, second and third sensing pixels SP1, SP2 and SP3 includes a transmissive area TA and a sensing area SA. The first, second and third color filters CF1, CF2 and CF3 are formed in the transmissive area TA. The image for inspecting the flicker is displayed on the transmissive area TA.

The first, second and third selection switching elements TRs1, TRs2 and TRs3 are formed in the sensing area SA of each of the first, second and third sensing pixels SP1, SP2 and SP3. The brightness (or the amount of light) of the image for inspecting the flicker is sensed through the sensing area SA.

The first polarizer 110a is disposed on a second surface of the first base substrate 101 opposite to the first surface of the first base substrate 101. The second polarizer 120a is disposed on a second surface of the second base substrate 201 opposite to the first surface of the second base substrate 201.

The light source 300 is disposed under the first polarizer 110a to provide light to the display panel 100. According to an exemplary embodiment, the light source 300 is disposed under a rear surface of the display panel 100.

The reflector 400 is disposed on a front surface of the display panel 100 corresponding to a position in which the sensor part 150 is formed to cover the sensor part 150. The reflector 400 reflects light transmitted through the transmissive area TA such that the reflected light from the reflector 400 is incident into the sensing area SA. According to an exemplary embodiment, the reflector 400 may include a receiving container, such as a top chassis disposed on the front surface of the display panel 100, to fix the display panel 100 and a reflective layer formed on a surface of the first polarizer 110a.

The sensor part 150 is operated as follows.

The first, second and third sensing pixels SP1, SP2 and SP3 display the image for inspecting the flicker, using light generated by the light source 300. Light corresponding to the brightness of the image for inspecting the flicker is emitted through the transmissive area TA. The emitted light through the transmissive area TA is reflected by the reflector 400 disposed on the front surface of the display panel 100 such that the reflected light by the reflector 400 is incident into the sensing area SA. The first, second and third selection switching elements TRs1, TRs2 and TRs3 sense the amount of the incident light into the sensing area SA. A sensing signal generated by the sensor part 150 in response to the amount (or the brightness) of the image for inspecting the flicker is outputted to the driving circuit 200 through the readout lines RL1, RL2 and RL3.

FIG. 4 is a block diagram illustrating an exemplary embodiment of the driving circuit shown in FIG. 1, according to the present invention.

Referring to FIGS. 1, 2 and 4, the driving circuit 200 includes a timing controller 210, a voltage providing circuit 220, a gate controlling circuit 230, a gamma voltage generating circuit 240, a source driving circuit 250, and a preventing flicker circuit 260.

The timing controller 210 generates a driving control signal controlling the driving circuit 200 in response to a control signal 200c provided by an external device (not shown). The driving control signal includes a gate control signal 210a, a power control signal 210b, a source control signal 210c, and a tuning control signal 210d. The gate control signal 210a controls the gate driving circuit 170. The power control signal 210b controls the power supply circuit 220. The source control signal 210c controls the source driving circuit 250. The tuning control signal 210d controls the preventing flicker circuit 260.

When the preventing flicker mode is operated, the timing controller 210 provides the source driving circuit 250 with inspection data 210e corresponding to the image for inspecting the flicker. The inspection data 210e includes black grayscale data, middle grayscale data and arbitrary grayscale data. The first sensing row SH1 of the sensor part 150 is provided with the black grayscale data. The second sensing row SH2 of the sensor part 150 is provided with the middle grayscale data or the arbitrary grayscale data.

According to an exemplary embodiment, the gate control signal 210a includes a vertical start signal STV, a first clock signal CK and a second clock signal CKB. When the preventing flicker mode is operated, the power supply circuit 220 is provided with the power control signal 210b so that the sensor part 150 is provided with the sensing driving voltage VD. The source control signal 210c includes a horizontal start signal, a pixel clock signal, a load signal, and an inversion signal. The tuning control signal 210d controls the preventing flicker circuit 260 when the preventing flicker mode is operated.

The power supply circuit 220 generates a driving voltage which includes a gate low voltage VGL, a gate high voltage VGH, a common voltage VCOM, a sensing driving voltage VD, and an analog power supply voltage AVDD. The timing controller 210 is provided with the gate low voltage VGL and the gate high voltage VGH. The timing controller 210 generates the first and second clock signals CK and CKB by using the gate low voltage VGL and the gate high voltage VGH. The gate low voltage VGL is further provided to the gate driving circuit 170.

The common voltage VCOM is provided to the display panel 100 to be applied to the liquid crystal capacitor CLC. The sensing driving voltage VD is provided to the voltage lines VL1, VL2 and VL3 of the sensor part 150 in response to the power control signal 210b when the preventing flicker mode is operated. The analog power supply voltage AVDD is provided to the gamma voltage generating circuit 240.

The gate controlling circuit 230 buffers the first clock signal CK, the second clock signal CKB and the vertical start signal STV and applies the first clock signal CK, the second clock signal CKB and the vertical start signal STV to the gate driving circuit 170.

The gamma voltage generating circuit 240 generates a plurality of gamma voltages VGAMMA and provides the source driving circuit 250 with the gamma voltages VGAMMA.

The source driving circuit 250 converts digital-type image data 200d provided by an external device (not shown) into an analog type grayscale voltage by using the gamma voltages and outputs the analog type grayscale voltage to the display panel 100. The source driving circuit 250 respectively applies the grayscale voltages D1, . . . , Dm to the m source lines DL1, . . . , DLm.

The preventing flicker circuit 260 determines a level of the common voltage corresponding to the flicker index to be smaller than the predetermined threshold value by using the sensing signal read out from the sensor part 150 when the preventing flicker mode is operated. According to the current exemplary embodiment, the preventing flicker circuit 260 provides the power supply circuit 220 with the common voltage control signal 260a to control the level of the common voltage VCOM.

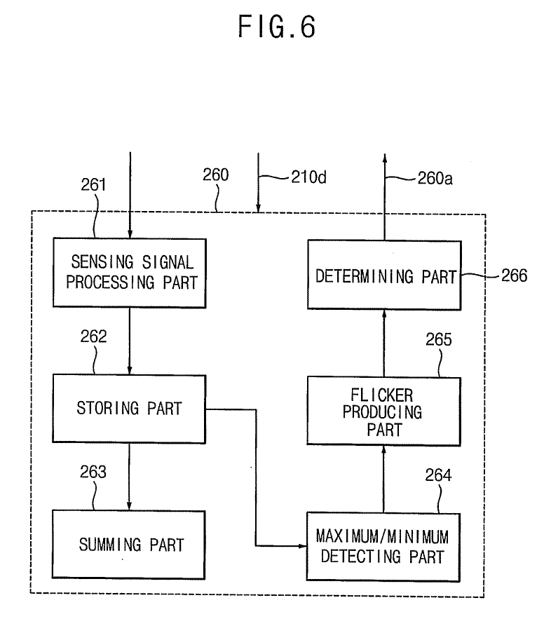

FIG. 5 is a timing diagram illustrating an exemplary embodiment of signals applied to a display panel during a frame when a preventing flicker mode is operated, according to the present invention. FIG. 6 is an exemplary embodiment of an image displayed on the display panel when the preventing flicker mode is operated, according to the present invention.

Referring to FIGS. 2, 4, 5, and 6, the source driving circuit 250 converts the inspection data 210e provided by the timing controller 210 and the image data 200d into analog type grayscale voltages and applies the analog type grayscale voltages to the source lines DL1, . . . , DLm.

The source driving circuit 250 outputs black grayscale data BG to the first sensing row SH1 and outputs middle grayscale data MG to the second sensing row SH2. During one horizontal period (H) during which the black grayscale data BG is outputted to the first sensing row SH1 the gate driving circuit 170 outputs a first dummy gate signal DG1 and the timing controller 210 outputs a first sensing gate signal Gs1 and a first driving gate signal Gd1. Therefore, the sensing pixels of the first sensing row SH1 display an image having a black grayscale, and the sensor part 150 senses the brightness (or the amount of light) of the image having the black grayscale and provides the preventing flicker circuit 260 with signals corresponding to the brightness (or the amount of light) of the image having the black grayscale.

During one horizontal period (1H) during which the middle grayscale data MG is outputted to the second sensing row SH2, the gate driving circuit 170 outputs a second dummy gate signal DG2, and the timing controller 210 outputs a second sensing gate signal Gs2 and a second driving gate signal Gd2. Therefore, the sensing pixels of the second sensing row SH2 display an image having a middle grayscale, and the sensor part 150 senses the brightness (or the amount of light) of the image having the middle grayscale and provides the preventing flicker circuit 260 with signals corresponding to the brightness (or the amount of light) of the image having the middle grayscale.

The source driving circuit 250 outputs image data by a horizontal line. The gate driving circuit 170 sequentially outputs n gate signals G1, G2, . . . , Gn−1, and Gn corresponding to the line image data L1, . . . , Ln outputted from the source driving circuit 250. Therefore, the display panel 100 displays images corresponding to one frame.

As mentioned above, the image for inspecting the flicker is not viewed because the first and second sensing rows SH1 and SH2 are covered by the reflector 400 such as the top chassis or the reflective layer.

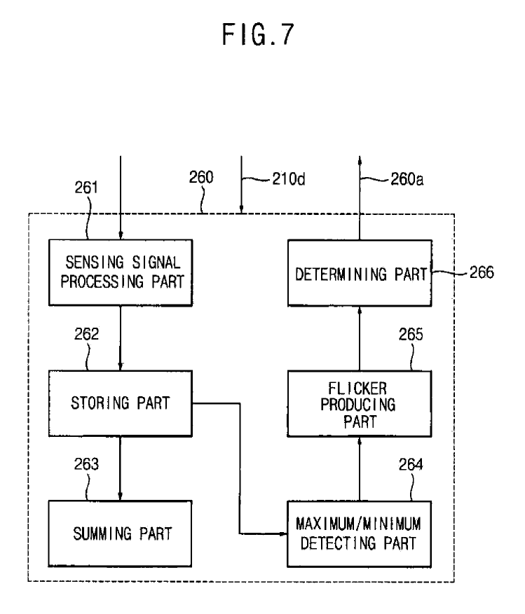

FIG. 7 is a block diagram illustrating the preventing flicker circuit 260 shown in FIG. 4.

Referring to FIGS. 2, 4 and 7, the preventing flicker circuit 260 includes a sensing signal processing part 261, a storing part 262, a summing part 263, a maximum/minimum detecting part 264, a flicker producing part 265, and a determining part 266.

According to an exemplary embodiment, the sensing signal processing part 261 converts a sensing signal read out from the sensor part 150 into a digital typed sensing data by every frame. According to an exemplary embodiment, the sensing signal processing part 261 converts the first, second, third, fourth, fifth, and sixth sensing signals respectively outputted from the first, second, third, fourth, fifth, and sixth selection switching elements TRs1, TRs2, TRs3, TRs4, TRs5, and TRs6 into the first, second, third, fourth, fifth, and sixth sensing data.

The storing part 262 stores the first sensing data, the second sensing data, the third sensing data, the fourth sensing data, the fifth sensing data, and the sixth sensing data.

The summing part 263 sums the first sensing data, the second sensing data, the third sensing data, the fourth sensing data, the fifth sensing data, and the sixth sensing data so that the storing part 262 stores the sum of the first sensing data, the second sensing data, the third sensing data, the fourth sensing data, the fifth sensing data, and the sixth sensing data. The storing part 262 stores the sums of the sensing data corresponding to a plurality of frames in order to produce the flicker index.

According to an exemplary embodiment, the maximum/minimum detecting part 264 detects a maximum value of the sums of the sensing data and a minimum value of the sums of the sensing data.

The flicker producing part 265 then produces the flicker index FI using the maximum value and the minimum value. The flicker index is determined by Equation 1 as follows.

$$FI = \frac{( Max - Min )}{\frac{( Max + Min )}{2}} \times 100 ( \% ) \qquad [ Equation 1 ]$$

The determining part 266 compares the flicker index FI produced by the flicker producing part 265 with a predetermined threshold value TH. When the flicker index FI is smaller than the predetermined threshold value TH, the determining part 266 controls the power supply circuit 220 to output the common voltage VCOM substantially equal to a present voltage applied to the liquid crystal capacitor CLC.

When the flicker index FI is greater than the threshold value TH, the determining part 266 outputs a common voltage control signal 260a controlling the power supply circuit 200 to control the level of the common voltage VCOM substantially equal to a predetermined level.

Accordingly, the display panel 100 displays the image for inspecting the flicker displayed under the controlled common voltage VCOM and the sensor part 150 outputs the sensing signal. The summing part 263, the maximum/minimum detecting part 264 and the flicker producing part 265 produce the flicker index FI. The determining part 266 compares the flicker index FI with the threshold value TH to control the power supply circuit 220 such that the power supply circuit 220 outputs the common voltage VCOM having the voltage level substantially equal to the predetermined level when the flicker index FI is smaller than the threshold value TH.

According to an exemplary embodiment, a plurality of the flicker indexes FI is produced. When all of the flicker indexes are smaller than the threshold value TH, the determining part 266 controls the power supply circuit 220 so that the power supply circuit 220 outputs the common voltage VCOM corresponding to a minimum flicker index.

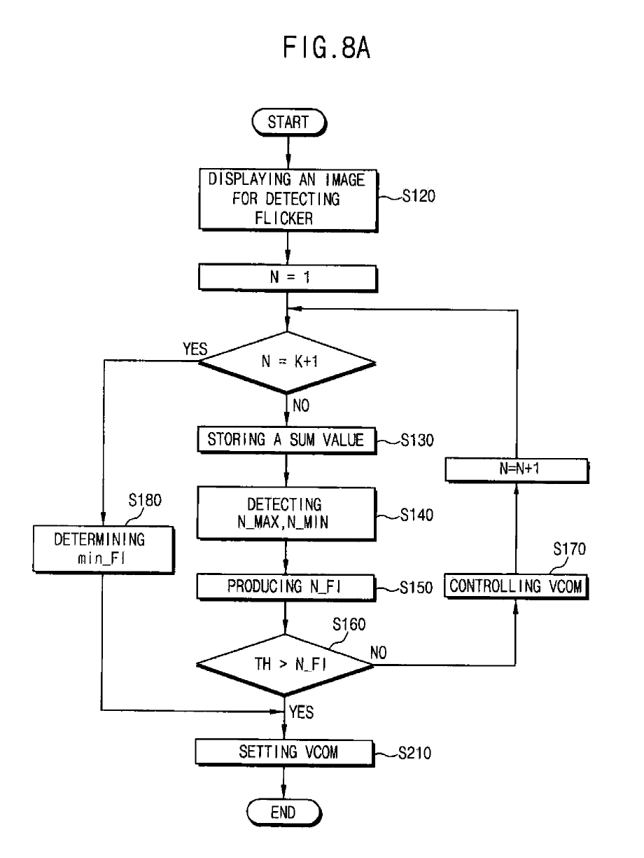

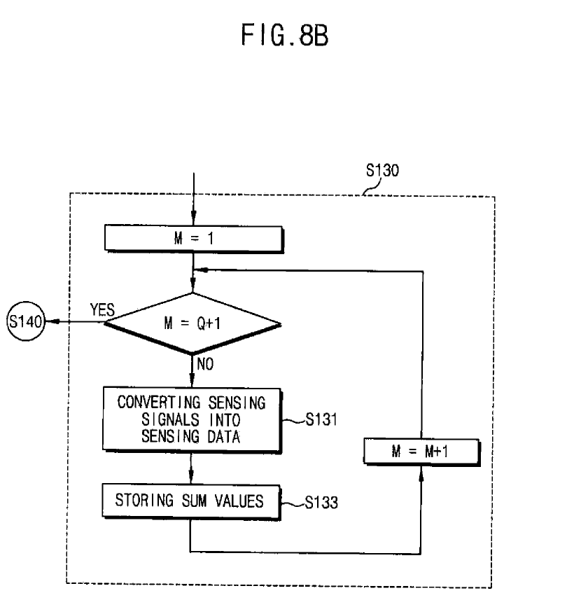

FIGS. 8A and 8B are a flow chart illustrating another exemplary embodiment of a method for preventing flicker according to the present invention.

Referring to FIGS. 7, 8A and 8B, the display panel 100 displays the image for inspecting the flicker when the preventing flicker mode is operated (operation S120).

The sensor part 150 senses the brightness of the image for inspecting the flicker to output the sensing signal. The sensing signal processing part 261 converts the readout sensing signals into digital sensing data (operation S131).

The summing part 263 sums the digital sensing data so that the storing part 262 stores the sum value of the digital sensing data (operation S133).

Operations 131 and 133 are repeated by a predetermined number Q of the frames. The storing part 262 stores Q flicker indexes (operation S130) where Q is a natural number. For example, M has an initial value of one (M=1) and is added by one (M=M+1) when M is not equal to (Q+1). The operations shown in FIG. 8B are repeated until M is equal to (Q+1). Therefore, the operations 131 and 133 are repeated by the predetermined number Q of the frame.

The maximum/minimum detecting part 264 detects a maximum flicker index N_Max and a minimum flicker index N_Min of the Q flicker indexes (operation S140). When N is 1, the maximum/minimum detecting part 264 detects a first maximum flicker index 1_Max and a first minimum flicker index 1_Min.

The flicker producing part 265 produces a flicker index N_FI using the maximum flicker index N_Max and the minimum flicker index N_Min. When N is 1, the flicker producing part 265 produces a first flicker index 1_FI using the first maximum flicker index 1_Max and the first minimum flicker index 1_Min (operation S150).

The determining part 266 compares the first flicker index 1_FI with the predetermined threshold value TH (operation S160). When the first flicker index 1_FI is smaller than the predetermined threshold value, the determining part controls the power supply circuit 220 such that the power supply circuit 220 outputs the common voltage substantially the same as a first common voltage VCOM1, which is substantially the same as a present voltage applied to the liquid crystal capacitor CLC (operation S210).

When the first flicker index 1_FI is greater than the threshold value TH, the determining part 266 controls the power supply circuit 220 such that the power supply circuit 220 outputs the common voltage substantially the same as a second common voltage VCOM2 (operation S170).

During operations 120, 130, 140 and 150, a second flicker index 1_FI is produced corresponding to the image for inspecting the flicker displayed under the second common voltage VOM2. The determining part 266 compares the second flicker index 2_FI with the threshold value TH (operation S160), and controls the power supply circuit 220 such that the power supply circuit 220 outputs the second common voltage VCOM2 when the second flicker index 2_FI is smaller than the threshold value TH (operation S210).

The determining part 266 determines a minimum flicker index min_FI of K flicker indexes 1_FI, 2_FI, . . . , K_FI when all of the K flicker indexes 1_FI, 2_FI, . . . , K_FI, which are produced until N is equal to K+1, are greater than the threshold value TH. K is a natural number more than 2 (operation S180). The determining part 266 controls the power supply circuit 220 so that the power supply circuit 220 outputs the common voltage min_VCOM corresponding to the minimum flicker index min_FI (operation S210).

According to an exemplary embodiment, the flicker is prevented through a method in which the power supply circuit 220 outputs the common voltage corresponding to the flicker index FI which is smaller than or equal to the threshold value TH.

According to the present invention, various types of flicker caused by differences in the processes or the components of a driving circuit may be suitably tuned since the driving circuit prevents flicker on a display panel. Therefore, the reliability of the flicker tuning and image quality may be improved.

While the present invention has been shown and described with reference to some exemplary embodiments thereof, it should be understood by those of ordinary skill in the art that various changes in form and details may be made therein without departing from the spirit and scope of the present invention as defined by appended claims.

What is claimed is:

1. A method of preventing flicker in a display panel, the method comprising:
displaying an inspection image on a plurality of sensing pixels formed in the display panel;
sensing an amount of light of the inspection image and outputting sensing signals corresponding to the amount of the light of the inspection image;
adding the sensing signals by every frame;
detecting a maximum value and a minimum value of sum values of the sensing signals;
producing a flicker index using the maximum value and the minimum value; and
comparing the flicker index with a predetermined threshold value such that a present common voltage applied to the display panel is maintained when the flicker index is smaller than the predetermined threshold value.

2. The method of claim 1, wherein adding the sensing signals comprises:
converting the sensing signals into digital sensing data; and
adding the digital sensing data.

3. The method of claim 1, wherein comparing the flicker index with the predetermined threshold value comprises:
controlling the common voltage such that the common voltage comprises a predetermined voltage level when the flicker index is greater than the predetermined threshold value.

4. The method of claim 1, wherein comparing the flicker index with the predetermined threshold value comprises:
controlling the common voltage such that the common voltage comprises a voltage level corresponding to a minimum flicker index of a plurality of flicker indexes when all of the flicker indexes are greater than the predetermined threshold value.

5. A circuit for preventing flicker of a display panel, the circuit comprising:
a sensing signal processing part which reads out sensing signals from the display panel which displays an inspection image and comprises a sensor part which senses an amount of light of the inspection image and outputs sensing signals corresponding to the amount of light of the inspection image;
a summing part which adds the sensing signals by every frame;
a maximum/minimum detecting part which detects a maximum value and a minimum value of sum values of the sensing signals corresponding to frames;
a flicker producing part which produces a flicker index using the maximum value and the minimum value; and
a determining part which maintains a common voltage of the display panel when the flicker index is smaller than a predetermined threshold value.

6. The circuit of claim 5, wherein the sensing signal processing part converts the sensing signals into digital sensing data, and the summing part adds the digital sensing data.

7. The circuit of claim 5, wherein the determining part controls the common voltage such that the common voltage comprises a voltage level corresponding to the flicker index smaller than the threshold value when the flicker index is greater than the threshold value.

8. The circuit of claim 5, wherein the determining part determines and controls the common voltage such that the common voltage comprises a voltage level corresponding to a minimum flicker index of flicker indexes produced according to levels of the common voltage when all of the flicker indexes are greater than the threshold value.

9. A display apparatus comprising:
a display panel which displays an inspection image and comprises a sensor part which senses an amount of light of the inspection image and outputs sensing signals; and
a driving device which produces a flicker index based on the sensing signals and determines a common voltage of the display panel by using the flicker index.

10. The display apparatus of claim 9, wherein the driving device comprises:
a power supply circuit which supplies the display panel with the common voltage;
a timing controller which drives the sensor part when a flicker preventing mode is employed; and
a flicker preventing circuit which produces a flicker index using the sensing signals read out from the sensor part and compares the flicker index with a predetermined threshold value to control the power supply circuit such that the power supply circuit controls a level of the common voltage.

11. The display apparatus of claim 10, wherein the flicker preventing circuit comprises:
a sensing signal processing part which converts the sensing signals into digital sensing data;
a summing part which adds the digital sensing data by every frame;
a maximum/minimum detecting part detecting a maximum value and a minimum value of sum values of the digital sensing data corresponding to frames;
a flicker producing part which produces a flicker index using the maximum value and the minimum value; and
a determining part which controls the power supply circuit such that the power supply circuit maintains the common voltage when the flicker index is smaller than the predetermined threshold value.

12. The display apparatus of claim 11, wherein the determining part controls the power supply circuit such that the power supply circuit controls the common voltage to have a voltage level corresponding to the flicker index smaller than the predetermined threshold value.

13. The display apparatus of claim 11, wherein the determining part controls the common voltage such that the common voltage comprises a voltage level corresponding to a minimum flicker index of flicker indexes produced according to levels of the common voltage when all of the flicker indexes are greater than the predetermined threshold value.

14. The display apparatus of claim 9, wherein the display panel comprises a display area including a plurality of pixels and the sensor part is formed in an end portion of the display area.

15. The display apparatus of claim 14, wherein the sensor part comprises a plurality of sensing pixels, each sensing pixel comprising:
a pixel switching element connected to a source line and a dummy gate line;
a liquid crystal capacitor connected to the pixel switching element such that each of the sensing pixels displays the inspection image;
a sensing switching element connected to a voltage line and a driving gate line; and
a selection switching element electrically connected to the sensing switching element, the selection switching element being connected to a read out line and a sensing gate line.

16. The display apparatus of claim 15, further comprising:
a light source which provides the display panel with light; and
a reflector which covers the sensor part and reflecting light emitted from the inspection image displayed on the sensor part.

17. The display apparatus of claim 16, further comprising:
a first polarizer disposed on a first surface of the display panel which polarizes light; and
a second polarizer disposed on a second surface of the display panel opposite to the first surface which polarizes light,
wherein the reflector comprises a reflective layer coated on the second polarizer.

18. The display apparatus of claim 16, wherein the reflector comprises a receiving container disposed on the display panel which fixes the display panel in a predetermined position.

19. The display apparatus of claim 15, wherein the display panel comprises a gate driving circuit formed in a peripheral area surrounding the display area, and the gate driving circuit provides pixels and the sensing pixels with gate signals and dummy gate signals, respectively.

20. The display apparatus of claim 19, wherein the driving circuit comprises:
a source driving circuit which applies image data to the pixels and applies inspection data to the sensing pixels; and
a gate control circuit which applies a gate control signal to the gate driving circuit.
